(19) United States
(12) Patent Application Publication
(10) Pub. No.: US 2024/0014384 A1
(43) Pub. Date: Jan. 11, 2024

(54) ION BATTERY ELECTRODE MATERIAL AND SYNTHESIZING METHOD THEREOF

(71) Applicant: RESEARCH & BUSINESS FOUNDATION SUNGKYUNKWAN UNIVERSITY, Suwon-si (KR)

(72) Inventors: Ho Seok PARK, Seongnam-si (KR); Jeong Seok YEON, Icheon-si (KR); Hwi Jung KIM, Daejeon (KR); Won Il KIM, Suwon-si (KR)

(73) Assignee: RESEARCH & BUSINESS FOUNDATION SUNGKYUNKWAN UNIVERSITY, Suwon-si (KR)

(21) Appl. No.: 18/218,657

(22) Filed: Jul. 6, 2023

(30) Foreign Application Priority Data
Jul. 11, 2022 (KR) 10-2022-0085037
Jul. 12, 2022 (KR) 10-2022-0085527

(51) Int. Cl. H01M 4/36; H01M 4/583; H01M 4/60; H01M 4/58; H01M 4/133; H01M 4/137; H01M 4/136; H01M 4/1393; H01M 4/1399; H01M 4/1397; H01M 4/04

(52) U.S. Cl. CPC H01M 4/366; H01M 4/583; H01M 4/602; H01M 4/5825; H01M 4/133; H01M 4/137; H01M 4/136; H01M 4/1393; H01M 4/1399; H01M 4/1397; H01M 4/04

(57) ABSTRACT

An embodiment of the present disclosure provides an ion battery electrode material that significantly improves scan rate, capacity exhibiting, safety, and energy density compared to conventional ion batteries by manufacturing bulk POM in a layered structure in which bulk POM is uniformly distributed in several nanometers on the surface of rGO/PPy, and a method for synthesizing ion battery electrode materials.

### CROSS REFERENCE TO RELATED APPLICATION

The present application claims priority to Korean Patent Application No. 10-2022-0085037, filed on Jul. 11, 2022, and No. 10-2022-0085527, filed on Jul. 12, 2022, the entire contents of which is incorporated herein for all purposes by this reference.

### BACKGROUND OF THE INVENTION

### Field of the Invention

The present disclosure relates to an ion battery, and relates to an ion battery electrode material and a method for synthesizing an ion battery electrode material that improves scan rate, capacity exhibiting, safety, and energy density.

### Description of the Related Art

Due to the current increase in consumption of fossil fuels and the resulting climate change, air pollution and environmental problems, development of new energy storage devices is required for sustainable development.

A supercapacitor, one of the conventional energy storage materials, has characteristics of high power density and long cycle life, but has a disadvantage of low energy density.

In addition, although conventional lithium ion batteries have high energy density, stored lithium is being depleted as demand for the lithium increases, and handling of lithium incorrectly can cause serious safety problems.

Therefore, it is necessary to develop a new inexpensive and safe energy storage material that can replace lithium while having a higher energy density than a supercapacitor.

As an alternative, aqueous batteries are used, and ion batteries such as zinc ion batteries, supercapacitors, sodium ion batteries, and magnesium ion batteries, which are inexpensive and environmentally friendly, are in the spotlight.

However, conventional electrode materials for ion batteries are low in scan rate, capacity exhibiting, safety, and the like, and also have low energy density, which are obstacles to commercialization of ion batteries.

Therefore, for the commercialization of ion batteries, the development of ion battery electrode materials with improved scan rate, capacity exhibiting, safety and energy density is required.

In addition, the most common technology among existing energy storage technologies is a lithium ion battery, which has the advantage of having a high electromotive force, but at the same time has an inherent limitation of a relatively low theoretical capacity. This is because the automatic mechanism of a lithium ion battery is based on an insertion reaction between lithium ions and an electrode active material. Due to this, the theoretical maximum capacity of the electrode active material is known to be about 250 mAh/g in the case of lithium oxide (anode) and about 370 mAh/g in the case of graphite (anode).

Sulfur, which is one of the most abundant materials on earth and has a high theoretical capacity, is attracting much attention as a candidate material for next-generation batteries that can solve the problem of low capacity of lithium ion batteries. However, currently developed lithium-sulfur batteries have many problems. Typical examples include volume expansion and low conductivity during charging and discharging, and polysulfide intermediate dissolution.

The polysulfide intermediate is an intermediate product produced through a process in which sulfur (S₈) used as an active material in an electrode is sequentially reduced. A high order polysulfide is dissolved in an electrolyte at a high order, but when the polysulfide intermediate is in the form of lithium disulfide (Li₂S₂) or lithium sulfide (Li₂S), it no longer dissolves in the electrolyte.

This characteristic of the polysulfide intermediate results in the dissolution of the high order polysulfide intermediate dissolved in the electrolyte to the opposite electrode due to the concentration difference, where it is reduced to a low order polysulfide and precipitated there. This acts as a cause of causing various serious problems such as loss of active material in the battery, continuous decrease in capacity, and low charge/discharge efficiency.

Therefore, as a technique for preventing the dissolution of such polysulfide intermediates, various technical attempts have been made, such as improving components of electrolytes or capturing polysulfide intermediates using nanostructures in electrodes, but these attempts are not practical.

Therefore, in order for lithium-sulfur batteries to be applied to the actual industry beyond the research and development stage, a technology to prevent the dissolution of polysulfide intermediates is required.

### Documents of Related Art

(Patent Document 1) KR Patent Application Publication No. 10-2014-0004640 (published on Jan. 13, 2014)

(Patent Document 2) KR Patent Application Publication No. 10-2014-0004640 (published on Jan. 13, 2014)

### SUMMARY OF THE INVENTION

In order to solve the above-mentioned conventional problems, an embodiment of the present disclosure has a technical object to provide an ion battery electrode material that significantly improves scan rate, capacity exhibiting, safety, and energy density compared to conventional ion batteries by manufacturing bulk POM in a layered structure in which bulk POM is uniformly distributed in several nanometers on the surface of rGO/PPy, and a method for synthesizing ion battery electrode materials.

In addition, in order to solve the above-mentioned conventional problems, an embodiment of the present disclosure has a technical object to provide a method for synthesizing a hollow sphered molybdenum dioxide sulfur nanocomposite capable of synthesizing a lithium sulfur battery electrode material that can prevent volume expansion during charging and discharging of a lithium sulfur battery, low conductivity, and polysulfide intermediate dissolution, and the synthesized nanocomposite.

The technical problem to be solved in the present disclosure are not limited to the above-mentioned technical problem, and any other technical problems not mentioned will be clearly understood from the following description by those skilled in the art.

In order to achieve the above technical object, an embodiment of the present disclosure provides an ion battery electrode material comprising a multilayer reduced graphene oxide polypyrrole and polyoxometalate laminated composite (L-rGO/PPy/POM laminated composite) in which a plurality of reduced graphene oxide polypyrrole polyoxometalate laminated composites (rGO/PPy/POM laminated composite) is laminated such that a polyoxometalated layer (a POM layer) formed by uniformly dispersing nano polyoxometalate (POM) is positioned on a reduced graphene oxide layer (a rGO layer), wherein the rGO/PPy/POM laminated composite is configured to comprise the reduced graphene oxide layer (the rGO layer); a polypyrrole layer (a PPy layer) laminated on the rGO layer; and the polyoxometalated layer (the POM layer) formed by uniformly dispersing the nano-polyoxometalate (POM) on the PPy layer.

In order to achieve the above technical object, another embodiment of the present disclosure provides a method for manufacturing an ion battery electrode configured to comprising producing a graphene oxide solution by dispersing graphene oxide (GO) in a solvent; producing a graphene oxide polypyrrole laminated composite (GO/PPy laminated composite) solution in which a graphene oxide layer and a polypyrrole layer are laminated by mixing poly pyrrole monomer (PPy) with the graphene oxide solution and then dispersing the poly pyrrole monomer; producing a layered reduced graphene oxide polypyrrole polyoxometalate laminated composite (rGO/PPy/POM laminated composite) solution in which nano-polyoxometalated layer (a POM layer) uniformly dispersed on an upper portion of the polypyrrole layer (PPy layer) is laminated by mixing and reacting a polyoxometalated precursor (a POM precursor) with the GO/PPy laminated composite solution to convert the graphene oxide layer into a reduced graphene oxide layer (a rGO layer); and producing a multilayered rGO/PPy/POM laminated composite (a L-rGO/PPy/POM laminated composite) solution in which a plurality of the rGO/PPy/POM laminated composites is laminated by stirring the rGO/PPy/POM laminated composite solution.

The POM of the POM precursor may have a Aₐ(BC_{b}O_{c}) structure, the A may be selected from the group consisting of elements in group 1 of a periodic table (e.g. H, Li, Na, K, Rb, Cs, etc.), elements in group 2 of the periodic table (e.g. Mg, Ca, etc.), transition metals (e.g. Co, V, Fe, Cu, Fe etc.), NH₄, and ligand, the B may be one selected from the group consisting of heterogeneous elements (e.g., N, B, S, P, etc.), Al and Ni, the C may be one selected from the group consisting of Mo, V and W, the a may be a number ranging from 0 to 15, the b may be a number ranging from 6 to 368, and the c may be a number ranging from 0 to 110.

The dispersion of the graphene oxide in the producing the graphene oxide solution may be performed by one or more selected from the group consisting of sonication for 1 to 3 hours, treatment of an organic solvent, and treatment of a surfactant. The organic solvent may include NMP, DMSO, DMF, or the like. The surfactant may include tetrabutylammonium hydroxide, cetrimonium bromide, sodium laucyl sulfate, sodium laureth sulfate, sodium dodecyl sulfate, or the like.

The dispersing of the PPy in the producing the GO/PPy laminated composite solution may be performed by one or more selected from the group consisting of stirring the PPy for 0.2 to 1 hours, sonication for 0.2 to 1 hours, and treatment of an organic solvent.

The stirring in the producing the layered L-rGO/PPy/POM laminated composite solution may be performed for 20 to 28 hours.

A weight ratio of the GO, PPy and POM may be 2 to 3:9 to 10:87 to 89.

In order to achieve the above technical object, an embodiment of the present disclosure provides a method for synthesizing a hollow sphered molybdenum dioxide sulfur nanocomposite configured to comprise producing a graphene oxide polypyrrole mixture solution by dispersing graphene oxide in a solvent and then mixing with poly pyrrole (C₄H₅N, PPy) monomer; producing a hollow sphered polyoxometalate nanocomposite (rGO/PPy/hollow sphered POM nanocomposite) solution in which reduced graphene oxide and polypyrrole are dispersed on a surface of hollow sphered polyoxometalate by mixing a polyoxometalate precursor (POM precursor) in the graphene oxide polypyrrole mixture solution and then stirring the mixture solution; producing a hollow sphered molybdenum dioxide nanocomposite (rGO/PPy/hollow sphered MoO₂ nanocomposite) solution in which the reduced graphene oxide and the polypyrrole are dispersed on the surface by performing hydrothermal synthesis treatment of the rGO/PPy/hollow sphered POM nanocomposite solution to synthesize the polyoxometalate into molybdenum dioxide (MoO₂); producing a hollow sphered molybdenum dioxide nanocomposite (N, P doped rGO/hollow sphered MoO₂ nanocomposite) in which nitrogen and phosphorus are doped and reduced graphene oxide is dispersed on the surface by heat-treating the rGO/PPy/hollow sphered MoO₂ nanocomposite; and producing a nitrogen and phosphate doped reduced graphene oxide hollow sphered molybdenum dioxide sulfur nanocomposite (N, P doped rGO/hollow sphered MoO₂/S nanocomposite) by mixing sulfur with the N, P-doped rGO/hollow sphered MoO₂ nanocomposite and then heat-treating the mixture to impregnate the molybdenum dioxide with sulfur.

In the producing the graphene oxide polypyrrole mixture solution, the graphene oxide and the pyrrole monomer may be mixed in a mass ratio of 200:0.5 to 200:2.

In the producing the rGO/PPy/hollow sphered POM nanocomposite solution, the polyoxometalate (POM) may have a Aₐ(BC_{b}O_{c}), the A may be selected from the group consisting of elements in group 1 of a periodic table (e.g. H, Li, Na, K, Rb, Cs, etc.), elements in group 2 of the periodic table (e.g. Mg, Ca, etc.), transition metals (e.g. Co, V, Fe, Cu, Fe etc.), NH₄, and ligand, the B may be one selected from the group consisting of heterogeneous elements (e.g., N, B, S, P, etc.), Al and Ni, the C may be one selected from the group consisting of Mo, V and W, the a may be a number ranging from 0 to 15, the b may be a number ranging from 6 to 368, and the c may be a number ranging from 0 to 110.

In the producing the rGO/PPy/hollow sphered POM nanocomposite solution, the polyoxometalate (POM) may be formed by doping one or more selected from the group consisting of a heterogeneous element and a transition metal to a (BC_{b}O_{c})⁻³ structure, the b may be a number ranging from 6 to 368, and the c may be a number ranging from 0 to 110.

In the producing the rGO/PPy/hollow sphered POM nanocomposite solution, the polyoxometalate (POM) may have a Aa(BCb-xDxOc), the A may be selected from the group consisting of an element in group 1 of a periodic table, an element in group 2 of the periodic table, a transition metal, NH₄, and ligand, the B may be one selected from the group consisting of a heterogeneous element, Al and Ni, the C may be one selected from the group consisting of Mo, V and W, the D may be substituted with a transition metal, the a may be a number ranging from 0 to 15, the b may be a number ranging from 6 to 368, the x may be a number ranging from 0 to 72, and the c may be a number ranging from 0 to 110.

In the producing the rGO/PPy/hollow sphered POM nanocomposite solution, the polyoxometalate (POM) added may be 0.05 mmol or more and 0.2 mmol or less, and the stirring may be performed for 15 to 20 hours.

In the producing the rGO/PPy/hollow sphered MoO₂ nanocomposite solution, the hydrothermal synthesis treatment may be performed at 170 to 190° C. for 11 to 13 hours.

In the producing the N, P doped rGO/hollow sphered MoO₂ nanocomposite, the heat treatment may be performed at to 950° C. for 1 to 3 hours to activate heteroatom doping by a carbonization process, so that the nitrogen of polypyrrole and the phosphorus of polyoxometalate are doped to produce the N, P doped rGO/hollow sphered MoO₂ nanocomposite.

In the producing the N, P doped rGO/hollow sphered MoO₂/S nanocomposite, the N, P-doped rGO/hollow sphered MoO₂ nanocomposite and sulfur may be mixed in a mass ratio of 1:2 to 1:4 and then the mixture may be heat-treated to impregnate the molybdenum dioxide with the sulfur to produce the nitrogen and phosphate doped reduced graphene oxide hollow sphered molybdenum dioxide sulfur nanocomposite (N, P-doped rGO/hollow sphered MoO₂/S nanocomposite).

In the producing the N, P doped rGO/hollow sphered MoO₂/S nanocomposite, the heat treatment may be performed in an inert gas atmosphere at 150 to 160° C. for 9 to 11 hours.

In order to achieve the above technical objects, another embodiment of the present disclosure provides a hollow sphered molybdenum dioxide sulfur nanocomposite which is a hollow sphered molybdenum dioxide sulfur nanocomposite (a N, P doped rGO/hollow sphered MoO₂/S nanocomposite) in which nitrogen and phosphorus are doped and reduced graphene oxide is dispersed on a surface, and which has a structure formed by impregnating sulfur in a hollow sphered molybdenum dioxide nanocomposite (a N, P doped rGO/hollow sphered MoO₂ nanocomposite) in which the nitrogen and the phosphorus are doped and the reduced graphene oxide is dispersed on the surface and which has a structure in which the nitrogen and the phosphorus are doped and the reduced graphene oxide is dispersed on a surface of the hollow sphered molybdenum dioxide nanocomposite formed of MoO₂ nanorods.

A mass ratio between the N, P-doped rGO/hollow sphered MoO₂ nanocomposite and the sulfur may be 1:2 to 1:6.

### BRIEF DESCRIPTION OF THE DRAWINGS

FIG. 1 is a laminated view of a multilayered reduced graphene oxide polypyrrole and polyoxometalate laminated composite (L-rGO/PPy/POM laminated composite) 1, which is an ion battery electrode material.

FIG. 2 is a flow chart illustrating the process of a method for manufacturing an ion battery electrode material, which is the L-rGO/PPy/POM laminated composite 1 in FIG. 1.

FIG. 3 is a view illustrating a composite produced for each step in the method of manufacturing an ion battery electrode material in FIG. 2.

FIG. 4 shows a SEM image of a layered L-rGO/PPy/POM laminated composite 1 for the stirring time of (a) 5 h (b) 10 h (c) 20 h (d) 40 h in the steps of producing the rGO/PPy/POM laminated composite solution.

FIG. 5 shows (a) a SEM image of a rGO/PPy/POM composite with spherical nanoparticles.

FIG. 6 shows SEM images of (a) PPy/POM laminated composite, (b) rGO, and (c) commercial POM powder.

FIG. 7A shows CV curves of the layered L-rGO/PPy/POM laminated composite according to the scan rate.

FIG. 7B shows the graph of the values obtained according to the power law of the scan rate and current value of each peaks (C1, C2, C3, C4/A1, A2, A3, A4) in FIG. 7A.

FIG. 7C shows the graph obtained using the Dunn's method for all points in the graph of FIG. 7A.

FIG. 7D shows bar graph in which the values obtained using Dunn's method in FIG. 7C are summarized by scan rate.

FIG. 7E shows CV curves of the rGO/PPy/POM composite with spherical nanoparticle according to the scan rate.

FIG. 7F shows the graph of the values obtained according to the power law of the scan rate and current value of each peaks (C1, C2, C3, C4/A1, A2, A3, A4) in FIG. 7E.

FIG. 7G shows the graph obtained using the Dunn's method for all points in the graph of FIG. 7E.

FIG. 7H shows bar graph in which the values obtained using Dunn's method in FIG. 7G are summarized by scan rate.

FIG. 8A shows graphs comparing CV curves of layered L-rGO/PPy/POM laminated composite 1 and PPy/POM laminated composite, rGO and commercial POM samples illustrated in FIG. 6.

FIG. 8B shows graphs comparing GCD curves of layered L-rGO/PPy/POM laminated composite 1 and PPy/POM laminated composite, rGO, and commercial POM samples illustrated in FIG. 6.

FIG. 9 is a flow chart illustrating the process of a method for synthesizing of a hollow sphered molybdenum dioxide sulfur nanocomposite (hereinafter referred to as, rGO/PPy/hollow sphered MoO₂/S nanocomposite) in which polyoxometalate (POM) precursor-based nitrogen and phosphorus are doped, and reduced graphene oxide is dispersed on the surface.

FIG. 10 is a view illustrating a solid sphered polyoxometalate nanocomposite (a rGO/PPy/solid sphered POM nanocomposite) in which the reduced graphene and polypyrrole produced in the processing of FIG. 9 are dispersed on a surface, a solid sphered polyoxometalate nanocomposite (a rGO/PPy/solid sphered POM nanocomposite) in which the reduced graphene and the polypyrrole are dispersed on a surface, a hollow sphered molybdenum dioxide nanocomposite (a rGO/PPy/hollow sphered MoO₂ nanocomposite) in which the reduced graphene and the polypyrrole are dispersed on a surface, a hollow sphered molybdenum dioxide nanocomposite (a rGO/hollow sphered MoO₂ nanocomposite doped with N, P) in which nitrogen and phosphorus are doped and the reduced graphene is dispersed on the surface, and a hollow sphered molybdenum dioxide sulfur nanocomposite (a N, P doped rGO/PPy/hollow sphered MoO₂—/S nanocomposite) in which nitrogen and phosphorus are doped and the reduced graphene is dispersed on a surface.

FIG. 11 shows (a) low-magnification scanning electron microscope (SEM) image, (b) high-magnification scanning electron microscope (SEM) image, and (c) scanning transmission electron microscope (dark-field STEM) image of N, P doped rGO/hollow sphered MoO₂ nanocomposite.

FIG. 12 shows transmission electron microscope (TEM) images of (a) N, P doped rGO/hollow sphered MoO₂ nanocomposite, (b) N, P doped rGO/hollow sphered MoO₂/S nanocomposite, (c) hollow sphered molybdenum dioxide sulfur nanocomposite in which nitrogen is doped and reduced graphene oxide is dispersed on the surface (hereinafter referred to as N-doped rGO/hollow sphered MoO₂/S nanocomposite), and (d) hollow sphered molybdenum dioxide nanocomposite in which reduced graphene oxide is dispersed on the surface (hereinafter referred to as rGO/hollow sphered MoO₂ nanocomposite).

FIG. 13 shows transmission electron microscope (TEM) images for structural comparison according to the stirring time of (a) 5 hours, (b) 10 hours, (c) 20 hours, (d) more than 20 hours (for 40 hours) in the process of synthesizing the rGO/hollow sphered POM nanocomposite 100.

FIG. 14 shows (a) a high-magnification transmission electron microscope (TEM) image and (b to g) C, Mo, O, S, P, and N elemental mapping of a sulfur-supported N, P-doped rGO/hollow sphered MoOₛ/S nanocomposite.

FIG. 15A shows a BET curve of a lithium sulfur battery electrode prepared of sulfur-supported N, P doped rGO/hollow sphered MoO₂/S nanocomposite 200.

FIG. 15B shows a symmetric cell polysulfide oxidation-reduction reaction current curve of a lithium sulfur battery electrode prepared of sulfur-supported N, P doped rGO/hollow sphered MoO₂/S nanocomposite 200.

FIG. 15C shows a impedance curve (Nyquist plot) of a lithium sulfur battery electrode prepared of sulfur-supported N, P doped rGO/hollow sphered MoO₂/S nanocomposite 200.

FIG. 16A shows a cyclic scanning current (CV) curve of a lithium sulfur battery electrode prepared of sulfur-supported N, P doped rGO/hollow sphered MoO₂/S nanocomposite 200.

FIG. 16B shows a scan rate characteristic evaluation curve of a lithium sulfur battery electrode prepared of sulfur-supported N, P doped rGO/hollow sphered MoO₂/S nanocomposite 200.

FIG. 16C shows a cyclic stability and capacity retention rate of a lithium sulfur battery electrode prepared of sulfur-supported N, P doped rGO/hollow sphered MoO₂/S nanocomposite 200.

### DETAILED DESCRIPTION OF THE INVENTION

The present disclosure will be described hereinafter with reference to the accompanying drawings. However, the present disclosure may be modified in various different ways, and the present disclosure is not limited to the described exemplary embodiments. Moreover, the part not related to the description will be omitted in order to clearly describe the present disclosure. Like reference numerals designate like elements throughout the specification.

Throughout the entire specification, when a part is connected (accessed, contacted, or coupled) with other parts, it includes “direct connection” as well as “indirect connection” in which the other member is positioned between the parts. In addition, unless explicitly described to the contrary, the word “comprise” will be understood to imply the inclusion of stated elements but not the exclusion of any other elements.

The terminology used herein is for the purpose of describing particular example embodiments only and is not intended to be limiting of the present disclosure. The singular forms are intended to include the plural forms as well, unless the context clearly indicates otherwise. It should be further understood that the terms “comprises” and/or “having,” when used in this specification, specify the presence of stated features, integers, steps, operations, elements, components or a combination thereof, but do not preclude the presence or addition of one or more other features, integers, steps, operations, elements, components, and/or combinations thereof.

As used in the description of embodiments of the disclosure, the term “nano composite” refers to a material that two or more materials are combined to express a more effective function while forming physically and chemically different phases to each other.

In the description of the embodiments of the present disclosure, a ‘hollow sphere structure’ refers to a spherical structure with a hollow inside formed by combining rods such as ‘MoO₂ rod’ or ‘S rod’.

In the description of the embodiment of the present disclosure, a ‘solid sphere structure’ refers to a ‘spherical structure filled inside’.

Hereinafter, embodiments of the present disclosure will be described in detail with reference to the accompanying drawings.

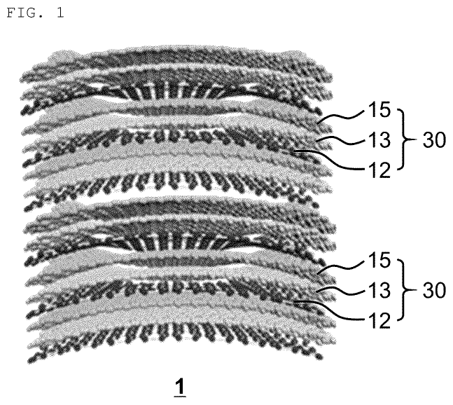

FIG. 1 is a laminated view of a multilayered reduced graphene oxide polypyrrole and polyoxometalate laminated composite (L-rGO/PPy/POM laminated composite) 1, which is an ion battery electrode material (cathode material).

As shown in FIG. 1, the layered L-rGO/PPy/POM laminated composite 1 may be configured by laminating a plurality of reduced graphene oxide polypyrrole polyoxometalate laminated composites (rGO/PPy/POM laminated composite) such that a polyoxometalated layer (a POM layer) formed by uniformly dispersing nano polyoxometalate (POM) is positioned on a reduced graphene oxide layer (a rGO layer).

The rGO/PPy/POM laminated composite may be configured to include a reduced graphene oxide layer (a rGO layer) 12, a polypyrrole layer (a PPy layer) 13 laminated on the rGO layer 12 and a polyoxometalated layer (a POM layer) 15 formed by uniformly dispersing nano-polyoxometalate (POM) on the PPy layer 15.

The POM of the POM precursor may have an Aa(BCbOc) structure.

Here, the A may be one selected from the group consisting of elements in group 1 of a periodic table (e.g. H, Li, Na, K, Rb, Cs, etc.), elements in group 2 of the periodic table (e.g. Mg, Ca, etc.), transition metals (e.g. Co, V, Fe, Cu, Fe etc.), NH₄, and ligand.

The B may be one selected from the group consisting of heterogeneous elements (e.g., N, B, S, P, etc.), Al and Ni.

The C may be one selected from the group consisting of Mo, V and W.

The a may be a number ranging from 0 to 15, the b may be a number ranging from 6 to 368, and the c may be a number ranging from 0 to 110. The weight ratio of the GO, PPy, and POM may be 2 to 3:9 to 10:87 to 89.

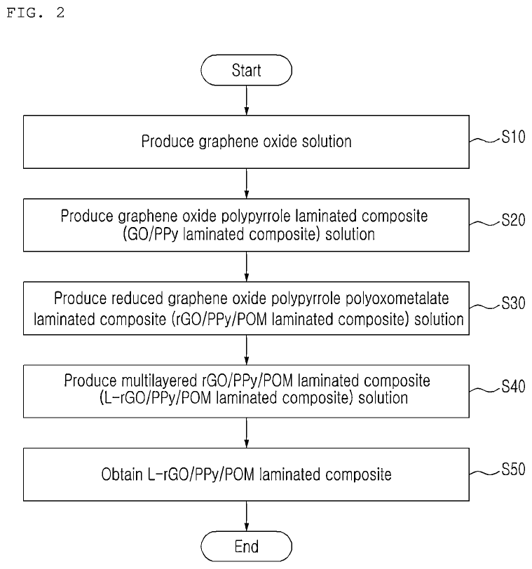

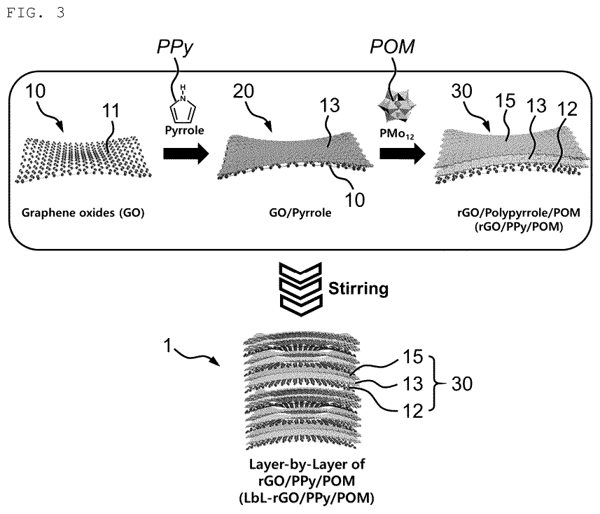

FIG. 2 is a flow chart illustrating the process of a method for manufacturing an ion battery electrode material, which is the L-rGO/PPy/POM laminated composite 1 in FIG. 1. And FIG. 3 is a view illustrating a composite produced for each step in the method of manufacturing an ion battery electrode material in FIG. 2.

As shown in FIGS. 2 and 3, the method for manufacturing an ion battery electrode material may be configured to include the steps of producing a graphene oxide solution S10, producing a graphene oxide polypyrrole laminated composite (GO/PPy laminated composite) solution S20, producing a reduced graphene oxide polypyrrole polyoxometalate laminated composite (rGO/PPy/POM laminated composite) solution S30, multilayered rGO/PPy/POM laminated composite (L-rGO/PPy/POM laminated composite) solution S40 and obtaining an L-rGO/PPy/POM laminated composite S50.

The step of producing a graphene oxide solution S10 may be the step of producing the graphene oxide solution by dispersing graphene oxide (GO) in a solvent.

The solvent may be distilled water, deionized water, ethanol, methanol or the like.

In the method for manufacturing the ion battery electrode material, the dispersion of the graphene oxide in the step of producing the graphene oxide solution S10 may be performed by one or more selected from the group consisting of sonication for 1 to 3 hours, treatment of an organic solvent, and treatment of a surfactant. The organic solvent may include NMP, DMSO, DMF, or the like. The surfactant may include tetrabutylammonium hydroxide, cetrimonium bromide, sodium laucyl sulfate, sodium laureth sulfate, sodium dodecyl sulfate, or the like.

In the step of producing the graphene oxide solution S10, the GO may be formed on a graphene oxide layer (a GO layer) 11 having a plate-like layer structure by the sonication.

In the step of producing a GO/PPy laminated composite solution S20, poly pyrrole monomer (PPy) is mixed with the graphene oxide solution and then dispersed to form a GO/PPy laminated composite 20 solution in which the polypyrrole layer (the PPy layer) 13 is laminated on the upper portion of the GO layer 11.

In the method for manufacturing the ion battery electrode material, the dispersing of the PPy in the producing the GO/PPy laminated composite solution may be performed by one or more selected from the group consisting of stirring the PPy for 0.2 to 1 hours, sonication for 0.2 to 1 hours, and treatment of an organic solvent.

The PPy layer 13 is laminated on the GO layer 11 by the dispersion of the PPy to form the GO/PPy laminated composite 20.

The step of producing the rGO/PPy/POM laminated composite solution S30 may be the step of converting the graphene oxide layer 11 into the reduced graphene oxide layer (the rGO layer) 12 by mixing and reacting a polyoxometalated precursor (a POM precursor) with the GO/PPy laminated composite 20 solution, and producing the layered reduced graphene oxide polypyrrole polyoxometalate laminated composite (the rGO/PPy/POM laminated composite) 30 solution in which the nano-polyoxometalated layer (the POM layer) 15 uniformly dispersed on the upper portion of the PPy layer 13 is laminated.

In the step of producing the layered L-rGO/PPy/POM laminated composite solution S40 may be the step of producing the multilayered rGO/PPy/POM laminated composite (the L-rGO/PPy/POM laminated composite) 1 solution in which a plurality of the rGO/PPy/POM laminated composites 30 is laminated by stirring the rGO/PPy/POM laminated composite 30 solution.

The stirring in the step of producing the L-rGO/PPy/POM laminated composite solution S40 may be performed for 20 to 28 hours.

By the stirring in the step of producing the L-rGO/PPy/POM laminated composite solution S40, the plurality of rGO/PPy/POM laminated composites 30 is laminated to produce the layered L-rGO/PPy/POM laminated composite 1 such that the rGO layer 12 is positioned on the upper portion of the POM layer 15.

The step of obtaining the L-rGO/PPy/POM laminated composite S50 may be the step of obtaining a precipitate of the synthesized L-rGO/PPy/POM laminated composite 1 by centrifuging the L-rGO/PPy/POM laminated composite 1 solution, washing the precipitate several times with a solvent until the supernatant of the precipitate becomes clear, and then freeze-drying the washed precipitate for 3 days in a vacuum to remove the solvent to obtain the L-rGO/PPy/POM laminated composite 1.

In the freeze-drying process, the layered L-rGO/PPyPOM laminated composite 1 in a powder state may be prepared by first freezing the solvent from a liquid to a solid at a low temperature using liquid nitrogen and then sublimating it to a gas phase at a low pressure.

The prepared L-rGO/PPy/POM laminated composite 1 has the same configuration and composition ratio as described in FIG. 1, and a detailed description thereof is omitted.

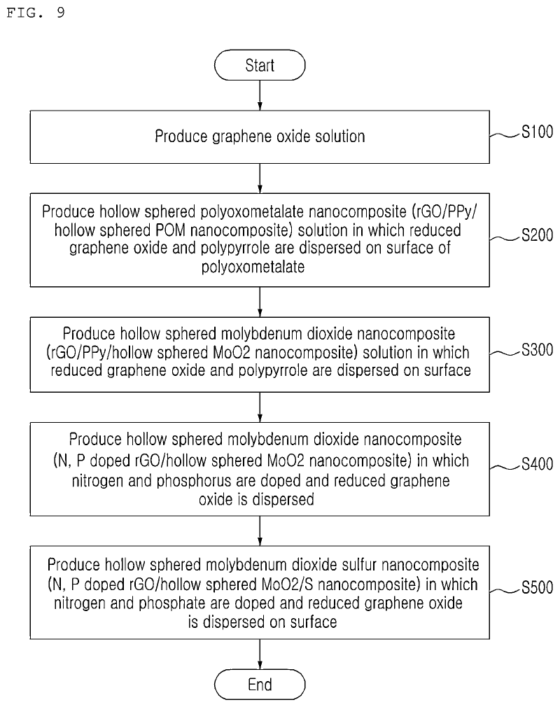

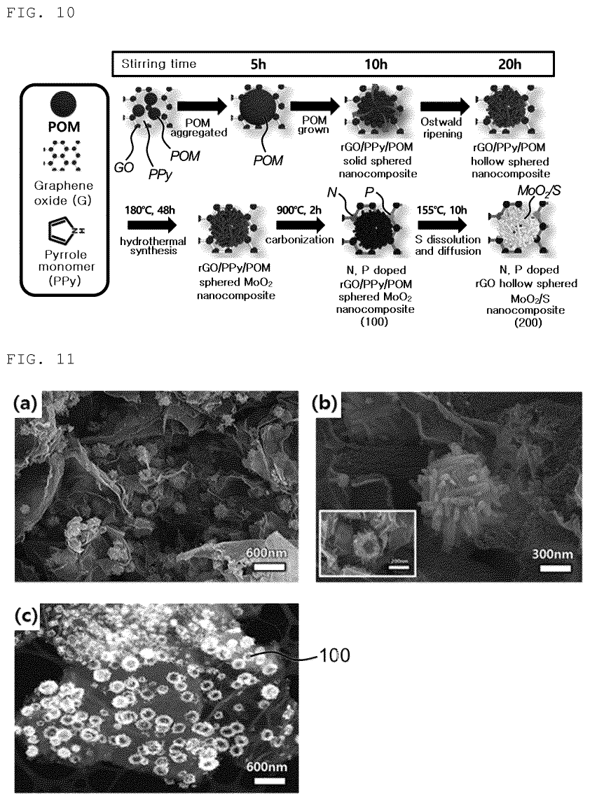

FIG. 9 is a flow chart illustrating the process of a method for synthesizing of a hollow sphered molybdenum dioxide sulfur nanocomposite (hereinafter referred to as, rGO/PPy/hollow sphered MoO₂/S nanocomposite) in which polyoxometalate (POM) precursor-based nitrogen and phosphorus are doped, and reduced graphene oxide is dispersed on the surface. FIG. 10 is a view illustrating a solid sphered polyoxometalate nanocomposite (a rGO/PPy/solid sphered POM nanocomposite) in which the reduced graphene and polypyrrole produced in the processing of FIG. 9 are dispersed on a surface, a solid sphered polyoxometalate nanocomposite (a rGO/PPy/solid sphered POM nanocomposite) in which the reduced graphene and the polypyrrole are dispersed on a surface, a hollow sphered molybdenum dioxide nanocomposite (a rGO/PPy/hollow sphered MoO₂ nanocomposite) in which the reduced graphene and the polypyrrole are dispersed on a surface, a hollow sphered molybdenum dioxide nanocomposite (a rGO/hollow sphered MoO₂ nanocomposite doped with N, P) in which nitrogen and phosphorus are doped and the reduced graphene is dispersed on the surface, and a hollow sphered molybdenum dioxide sulfur nanocomposite (a rGO/PPy/hollow sphered MoO₂—/S nanocomposite doped with N, P) in which nitrogen and phosphorus are doped and the reduced graphene is dispersed on a surface.

As shown in FIGS. 9 and 10, the method for synthesizing the hollow sphered molybdenum dioxide sulfur nanocomposite may be configured to include the steps of producing a graphene oxide polypyrrole mixture solution S100, producing a hollow sphered polyoxometalate nanocomposite (hereinafter referred to as a rGO/PPy/hollow sphered POM nanocomposite) solution in which reduced graphene oxide and polypyrrole are dispersed on the surface S200, producing a reduced graphene oxide polypyrrole hollow sphered molybdenum dioxide nanocomposite (hereinafter referred to as a rGO/PPy/hollow sphered MoO₂ nanocomposite) solution S300, producing a hollow sphered molybdenum dioxide nanocomposite (hereinafter referred to as N, P doped rGO/hollow sphered MoO₂ nanocomposite) in which nitrogen and phosphorus of polyoxometalate are doped and reduced graphene oxide is dispersed on the surface S400, and producing a nitrogen and phosphate doped reduced graphene oxide hollow sphered molybdenum dioxide sulfur nanocomposite (N, P doped rGO/hollow sphered MoO₂/S nanocomposite) by mixing sulfur with the N, P-doped rGO/hollow sphered MoO₂ nanocomposite and then heat-treating the mixture to impregnate the molybdenum dioxide with sulfur.

The step of producing a graphene oxide polypyrrole mixture solution S100 may be the step of producing the graphene oxide polypyrrole mixture solution by dispersing graphene oxide in a solvent and then mixing with poly pyrrole (C₄H₅N, PPy) monomer.

In the step of producing the graphene oxide polypyrrole mixture solution S100, the graphene oxide (GO) and the polypyrrole (PPy) monomer may be mixed in a mass ratio of 200:0.5 to 200:2.

The step of producing a rGO/PPy/hollow sphered POM nanocomposite solution 200 may be the step of producing the rGO/PPy/hollow sphered POM nanocomposite solution in which the reduced graphene oxide and the polypyrrole are dispersed on the surface of the hollow sphered polyoxometalate by mixing and stirring a polyoxometalate precursor with the graphene oxide polypyrrole mixture solution.

The polyoxometalate (POM) may have an Aₐ(BC_{b}O_{c}) structure.

Here, the A may be one selected from the group consisting of elements in group 1 of a periodic table (e.g. H, Li, Na, K, Rb, Cs, etc.), elements in group 2 of the periodic table (e.g. Mg, Ca, etc.), transition metals (e.g. Co, V, Fe, Cu, Fe etc.), NH₄, and ligand.

The B may be one selected from the group consisting of heterogeneous elements (e.g., N, B, S, P, etc.), Al and Ni.

The C may be one selected from the group consisting of Mo, V and W.

12 The a is a number ranging from 0 to 15, the b is a number ranging from 6 to 368, and the c may be a number ranging from 0 to 110.

In addition, the polyoxometalate (POM) may be formed by doping one or more selected from the group consisting of heterogeneous elements (e.g., N, B, S, P, O, etc.) and transition metals (e.g., Co, Fe, etc.) to a (BC_{b}O_{c})⁻³ structure, and the b may be a number ranging from 6 to 368, and the c may be a number ranging from 0 to 110.

In addition, the polyoxometalate (POM) may have a Aₐ(BC_{b-x}DₓO_{c}) structure. The A may be one selected from the group consisting of elements in group 1 of a periodic table (e.g. H, Li, Na, K, Rb, Cs, etc.), elements in group 2 of the periodic table (e.g. Mg, Ca, etc.), transition metals (e.g. Co, V, Fe, Cu, Fe etc.), NH₄, and ligand. The B may be one selected from the group consisting of heterogeneous elements (e.g., N, B, S, P, etc.), Al and Ni. The C may be one selected from the group consisting of Mo, V and W. The D may be substituted with a transition metal (e.g., Co, V, Fe, etc.).

The a may be a number ranging from 0 to 15, the b may be a number ranging from 6 to 368, the x may be a number ranging from 0 to 72, and the c may be a number ranging from to 110.

In addition, the polyoxometalate (POM) added in the step of producing the rGO/PPy/hollow sphered POM nanocomposite solution S200 may be 0.05 mmol or more and 0.2 mmol or less. The stirring may be performed for 15 to 20 hours.

In this process, as the stirring proceeds in the graphene oxide polypyrrole polyoxometalate (POM) precursor mixture solution, the polyoxometalate (POM) is aggregated and then grown to form a solid sphered POM nanocomposite (hereinafter referred to as a rGO/PPy/solid sphered POM nanocomposite) in which the reduced graphene oxide and the polypyrrole are dispersed on the surface. Then, through an ostwald ripening process, the POM solid sphere structure is converted into a hollow sphere structure, thereby forming the rGO/PPy/hollow sphered POM nanocomposite.

In the step of producing the rGO/PPy/hollow sphered MoO₂ nanocomposite solution S300, the rGO/PPy/hollow sphered POM nanocomposite solution may be the step of synthesizing the molybdenum dioxide (MoO₂) with hydrothermal synthesis treatment to produce the rGO/PPy/hollow sphered MoO₂ nanocomposite solution.

The hydrothermal synthesis treatment may be performed at 170 to 190° C. for 11 to 13 hours.

By the hydrothermal synthesis treatment, the rGO/PPy/hollow sphered POM nanocomposite sphered MoO₂ nanocomposite is synthesized.

The step of producing the N, P doped rGO/hollow sphered MoO₂ nanocomposite S400 may be the step of obtaining and then heat-treating the rGO/PPy/hollow sphered MoO₂ nanocomposite to produce the hollow sphered molybdenum dioxide nanocomposite (N, P doped rGO/hollow sphered MoO₂ nanocomposite) in which nitrogen and phosphorus are doped and reduced graphene oxide is dispersed on the surface.

The heat treatment may be performed at 850 to 950° C. for 1 to 3 hours to activate heteroatom doping by a carbonization process, so that the nitrogen of polypyrrole and the phosphorus of polyoxometalate are doped, resulting in production of the N, P doped rGO/hollow sphered MoO₂ nanocomposite.

The step of producing the N, P doped rGO/hollow sphered MoO₂/S nanocomposite S500 may be the step of producing the hollow sphered molybdenum dioxide sulfur nanocomposite (hereinafter referred to as N, P doped rGO/hollow sphered MoO₂/S nanocomposite) in which the nitrogen and the phosphorus are doped and the reduced graphene oxide is dispersed on the surface.

The N, P-doped rGO/hollow sphered MoO₂/S nanocomposite may be used as an electrode material for a lithium sulfur battery.

In the step of producing the N, P-doped rGO/hollow sphered MoO₂/S nanocomposite S500 may be the step of mixing the N, P-doped rGO/hollow sphered MoO₂ nanocomposite and sulfur (S) in a mass ratio of 1:2 to 1:4 and then heat-treating the mixture to impregnate the molybdenum dioxide with sulfur (S), thereby producing the N, P-doped rGO/hollow sphered MoO₂/S nanocomposite.

The heat treatment may be performed in an inert gas atmosphere at 150 to 160° C. for 9 to 11 hours.

By the method for synthesizing a hollow sphered molybdenum dioxide sulfur nanocomposite, a hollow sphered molybdenum dioxide sulfur nanocomposite which is a hollow sphered molybdenum dioxide sulfur nanocomposite (a N, P doped rGO/hollow sphered MoO₂/S nanocomposite) in which nitrogen and phosphorus are doped and reduced graphene oxide is dispersed on a surface, and which has a structure formed by impregnating sulfur in a hollow sphered molybdenum dioxide nanocomposite (a N, P doped rGO/hollow sphered MoO₂ nanocomposite) in which the nitrogen and the phosphorus are doped and the reduced graphene oxide is dispersed on the surface and which has a structure in which the nitrogen and the phosphorus are doped and the reduced graphene oxide is dispersed on a surface of the hollow sphered molybdenum dioxide nanocomposite formed of MoO₂ nanorods, is synthesized.

A mass ratio between the N, P-doped rGO/hollow sphered MoO₂ nanocomposite and the sulfur may be 1:2 to 1:6.

The N, P-doped rGO/hollow sphered MoO₂/S nanocomposite may be used as an electrode material for a lithium sulfur battery.

### EXPERIMENTAL EXAMPLES

A graphene oxide (GO) solution (solution A) was prepared by putting graphene oxide (GO) in deionized water as a solvent and performing sonication for 1 hour to disperse the graphene oxide.

After mixing the pyrrole monomer in the solution A, stirring was performed for 30 minutes to prepare a GO/PPy laminated composite 20 solution (solution B) in which the polypyrrole layer (the PPy layer) 13 is laminated on an upper portion of the graphene oxide layer (the GO layer) 11.

After mixing H₃PMo₁₂O₄₀ acid (phosphomolybrid acid) containing molybdenum (Mo) in polyoxometalate with the solution B, it was stirred for 24 hours for dispersing and self-assembling into a layered structure to convert the graphene oxide layer (the GO layer) 11 into the reduced graphene oxide layer (the rGO layer) 12 and to produce a layered reduced graphene oxide polypyrrole polyoxometalate laminated composites (a rGO/PPy/POM laminated composite) 30 in which the nano polyoxometalated layer (POM layer) 15 uniformly dispersed on the upper portion of the PPy layer 13 is laminated. Then, by laminating the rGO/PPy/POM laminated composites 30 in a plurality of layers, a multilayered reduced graphene oxide layer/polypyrrole layer/polyoxometalated layer laminated composite (the L-rGO/PPy/POM laminated composite) 1 solution (solution C) was prepared. The L indicates that layers are sequentially stacked, and means Layer-by Layer.

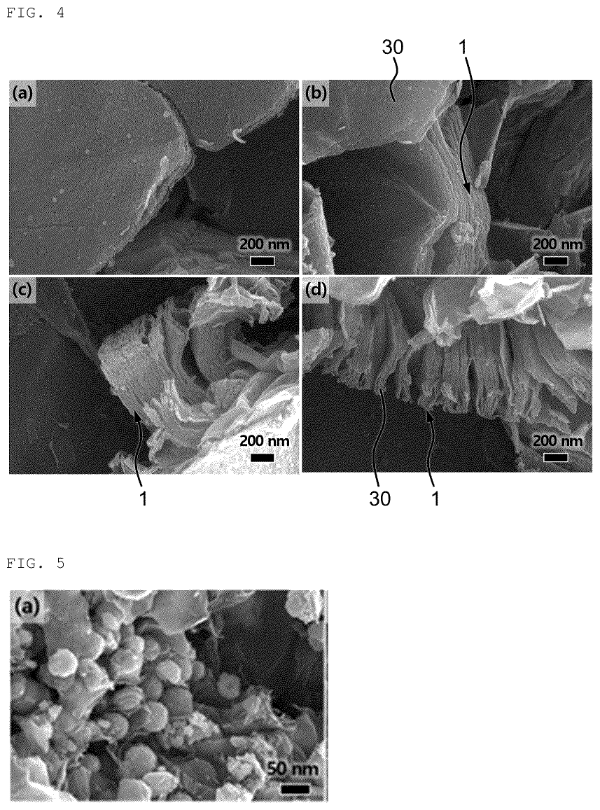

FIG. 4 shows a SEM image of a layered L-rGO/PPy/POM laminated composite 1 for the stirring time of (a) 5 h (b) 10 h (c) 20 h (d) 40 h in the steps of producing the L-rGO/PPy/POM laminated composite 1 solution (solution C).

As shown in FIG. 4, it was confirmed that as the stirring progressed, the rGO/PPy/POM laminated composite 30 was produced into the layered L-rGO/PPy/POM laminated composite 1.

Thereafter, a precipitate of the L-rGO/PPy/POM laminated composite 1 synthesized from the solution C was obtained using a centrifuge and washed several times with a solvent until the supernatant became clear.

The precipitate of the synthesized L-rGO/PPy/POM laminated composite 1 was freeze-dried in a vacuum for 3 days to remove the solvent.

In the freeze-drying process, distilled water was first frozen from a liquid to a solid at a low temperature using liquid nitrogen, and then sublimated to a gas phase at a low pressure to prepare the L-rGO/PPy/POM laminated composite 1 in a power state.

The weight ratio of graphene oxide (GO), polypyrrole (PPy) monomer, and H₃PMo₁₂O₄₀ used for the prepared layered L-rGO/PPy/POM laminated composite 1 was 2.4:9.4:88.2 in weight ratio.

A zinc ion battery was prepared by including zinc metal (cathode), a separator (glassy fiber), an electrolyte, and an anode having the prepared layered L-rGO/PPy/POM laminated composite 1.

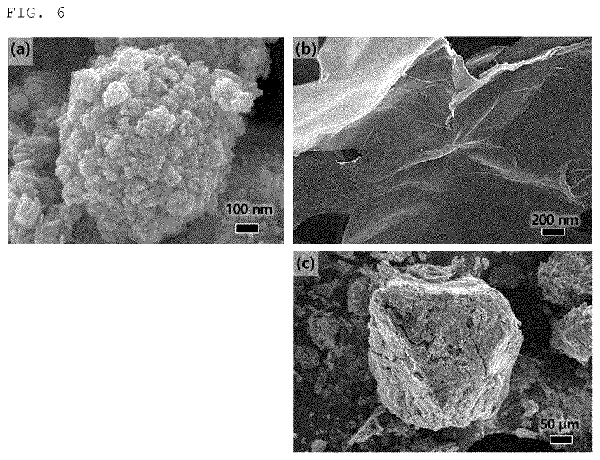

FIG. 5 shows (a) a SEM image of a rGO/PPy/POM composite with spherical nanoparticles.

The rGO/PPy/POM composite 25 having spherical nanoparticles is a comparative sample for showing the superiority of the L-rGO/PPy/POM laminated composite 1, and has the same composition as the L-rGO/PPy/POM laminated composite 1.

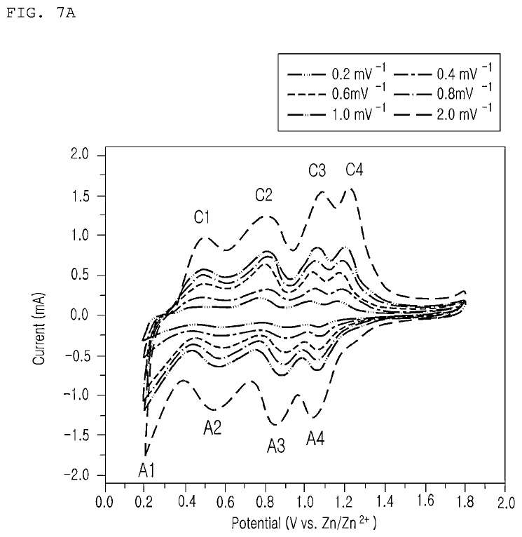

FIG. 6 shows SEM images of (a) PPy/POM laminated composite, (b) rGO, and (c) commercial POM powder.

(a) PPy/POM laminated composite, (b) rGO, and (c) commercial POM powder in FIG. 6 are also comparative samples to show the superiority of the L-rGO/PPy/POM laminated composite.

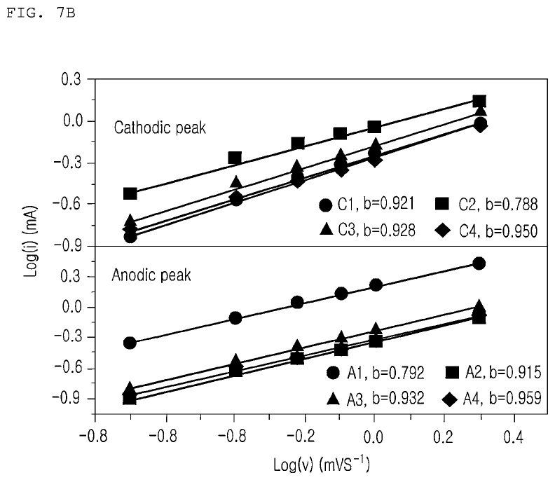

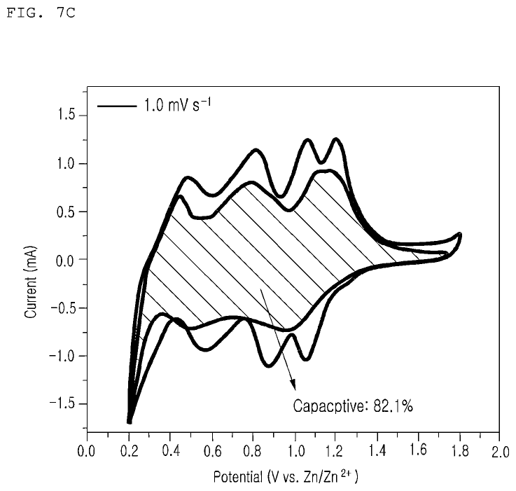

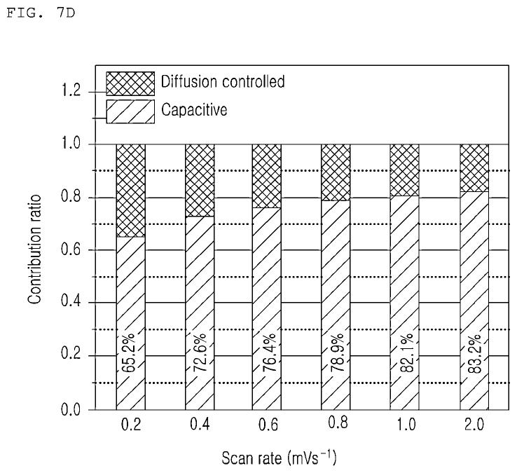

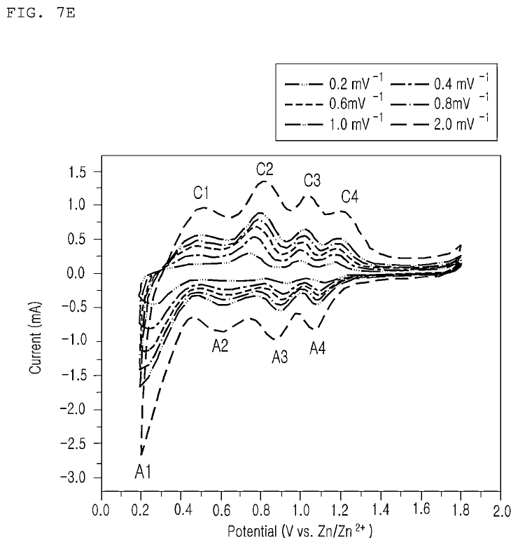

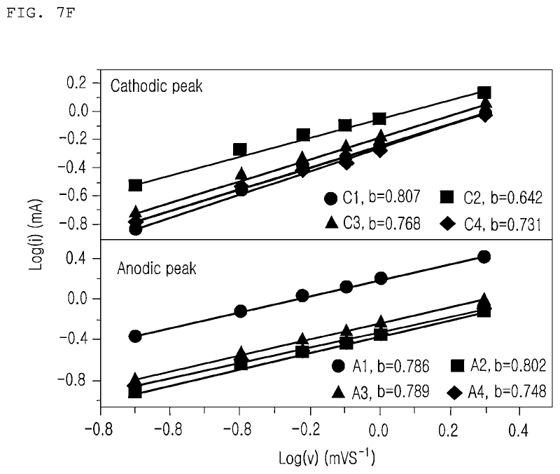

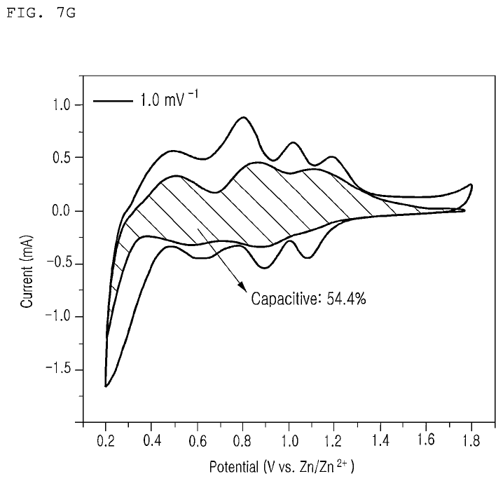

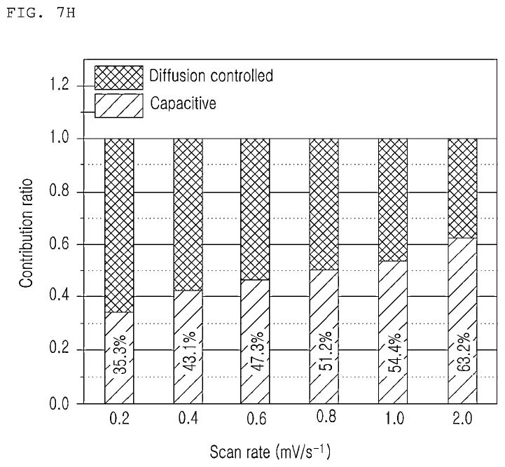

FIG. 7 shows graphs comparing CV curves and electrochemical mobility according to scan rate of the comparative samples of the rGO/PPy/POM composite with spherical nanoparticles presented in FIG. 5 to compare the superiority of the layered L-rGO/PPy/POM laminated composite 1.

In FIG. 7, (a to d) are graphs comparing the CV curves and the degree of excellence in electrochemical mobility according to scan rate of the layered L-rGO/PPy/POM laminated composite 1, and (e to h) are graphs comparing the CV curves and the degree of excellence in electrochemical mobility according to scan rate of the rGO/PPy/POM composite with spherical nanoparticles.

In FIG. 7, (a) and (e) are the CV curves of the rGO/PPy/POM composite with spherical nanoparticle and the layered L-rGO/PPy/POM laminated composite according to the scan rate, respectively, Here, four oxidation-reduction reactions were confirmed during charging and discharging. The (b) and (f) graphs show the summary of the values obtained according to the power law of the scan rate and current value of each of the four peaks. The b value in the layered L-rGO/PPy/POM laminated composite was higher than that in the rGO/PPy/POM with spherical nanoparticle, and the layered L-rGO/PPy/POM laminated composite was excellent at high charge/discharge rates. In FIG. 7, (c) and (g) were obtained using the Dunn's method for all points in the graphs (a) and (e), and the layered L-rGO/PPy/POM laminate composite exhibited higher capacitive. In (d) and (h) in FIG. 7 where Dunn's method was summarized by scan rate, the layered L-rGO/PPy/POM laminated composite has a higher capacitive contribution ratio among a total capacitive.

As shown in FIG. 7, in terms of electrochemical motility such as CV curve, oxidation and reduction peaks, and capacitive according to scan rate, it was confirmed in (a to d) of the embodiment of the present disclosure that the layered L-rGO/PPy/POM laminated composite 1 was superior to the rGO/PPy/POM composite with spherical nanoparticles in FIG. 5.

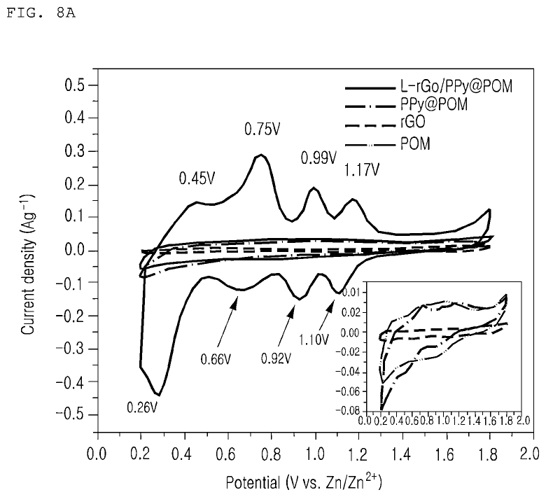

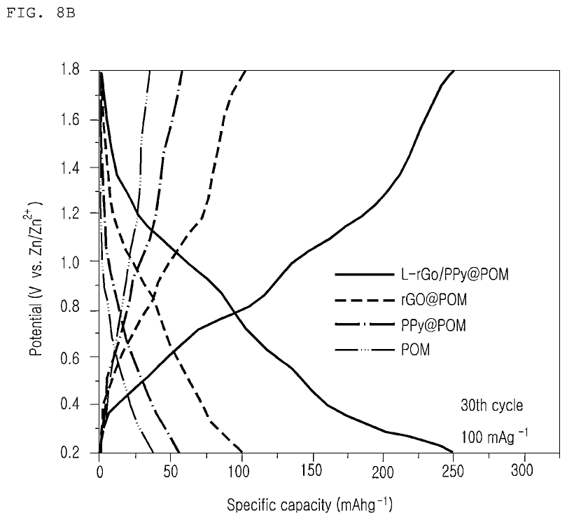

FIG. 8 shows graphs comparing (a) CV curves and (b) GCD curves of layered L-rGO/Ppy/POM laminated composite 1 and PPy/POM laminated composite, rGO and commercial POM samples illustrated in FIG. 6.

In FIG. 8, (a) shows an evaluation of electrochemical activity using a CV curve. The layered L-rGO/PPy/POM laminated composite exhibited high current density and excellent electrochemical activity compared to other rGO and commercial POM samples. In FIG. 8, (b) GCD graph, as shown in the CV curve, confirmed that the L-rGO/PPy/POM laminated composite exhibited a higher capacity than those of other samples.

It can be seen from FIG. 8 that the layered L-rGO/PPy/POM laminated composite 1 of the present disclosure provides significantly better electrochemical performance in terms of CV characteristics and charge and discharge capacity, compared to the comparative samples in FIG. 6.

The prepared layered L-rGO/PPy/POM composite 30 has a unique layered structure, and since rGO/PPy acts as a pseudo-capacitive material that greatly improves electrochemical performance, the L-rGO/PPy/POM composite 30 can be applied as an electrode material for energy storage systems such as zinc ion batteries, supercapacitors, sodium ion batteries, and magnesium ion batteries.

In order to effectively disperse the graphene oxide (GO) in distilled water as a solvent, sonication was performed for 1 hour to synthesize the graphene oxide solution (solution A). Ethanol or the like may be used as a solvent.

After mixing the polypyrrole (PPy) monomer in the solution A, stirring was performed for 30 minutes to effectively disperse the mixture, and then the graphene oxide polypyrrole mixture solution (solution B) was synthesized.

Phosphorus molybdic acid (H₃PMo₁₂O₄₀) in polyoxometalate (POM) was mixed with the solution B, and then stirred for 20 hours to effectively disperse and self-assemble into a layered structure, so that the rGO/PPy/hollow sphered POM nanocomposite solution (solution C) was synthesized.

The optimal mixing ratio of graphene oxide (GO), polypyrrole (PPy) monomer, and phosphomolybdic acid is 2.4:9.4:88.2 by weight.

12 The solution C was hydrothermally synthesized at 180° C. for 12 hours using a Teflon liner to synthesize the polyoxometalate of the rGO/PPy/hollow sphered POM nanocomposite with molybdenum dioxide (MoO₂) to produce the rGO/PPy/hollow sphered MoO₂ nanocomposite solution.

The homogeneous mixture solution was centrifuged to obtain the synthesized precipitate, rGO/PPy/hollow sphered MoO₂ nanocomposite, and washed with a solvent several times until the supernatant of the precipitate became clear.

The synthesized rGO/PPy/hollow sphered MoO₂ nanocomposite was freeze-dried in a vacuum for 3 days to remove the solvent.

In the freeze-drying process, distilled water was first frozen from a liquid to a solid at a low temperature using liquid nitrogen, and then sublimated to a gas phase at a low pressure to obtain the rGO/PPy/hollow sphered MoO₂ nanocomposite in a powder state.

Methanol and ethanol may also be used as the solvent.

The rGO/PPy/hollow sphered MoO₂ nanocomposite is carbonized by heat treatment at 900° C. for 2 hours to activate heteroatom doping to synthesize the N, P doped rGO/hollow sphered MoO₂ nanocomposite.

The N, P-doped rGO/hollow sphered MoO₂ nanocomposite was mixed with sulfur so that the mass ratio of the N, P-doped rGO/hollow sphered MoO₂ nanocomposite and sulfur (S) was 1:3, and then heat-treated at 155° C. for 10 hours in an Ar atmosphere to synthesize the N, P-doped rGO/hollow sphered MoO₂/S nanocomposite.

A lithium sulfur battery electrode was manufactured using the synthesized N, P doped rGO/hollow sphered MoO₂/S nanocomposite.

In order to evaluate an anti-dissolution effect of the polysulfide of the lithium sulfur battery electrode, a mixture of a dimethoxyethane solution and dioxolane solution in a 1:1 ratio and the mixture solution containing a high concentration of polysulfide molecules were used, respectively.

An experiment to evaluate the anti-dissolution performance of the polysulfide intermediate was conducted inside a glove box filled with argon gas.

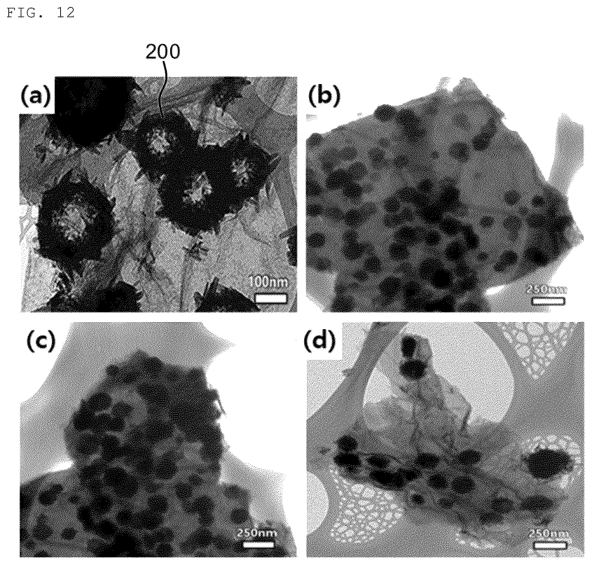

FIG. 11 shows (a) low-magnification scanning electron microscope (SEM) image, (b) high-magnification scanning electron microscope (SEM) image, and (c) scanning transmission electron microscope (dark-field STEM) image of N, P doped rGO/hollow sphered MoO₂ nanocomposite.

From FIG. 11, it was confirmed that the N, P-doped rGO/hollow sphered MoO₂ nanocomposite 100 having hollow sphered MoO₂ rods was synthesized.

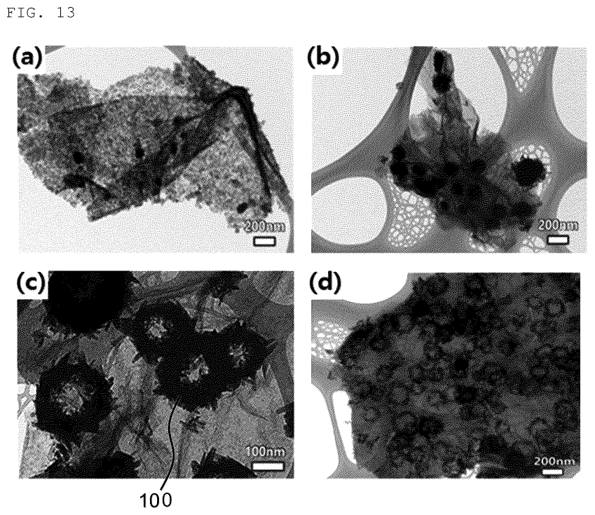

FIG. 12 shows transmission electron microscope (TEM) images of (a) N, P doped rGO/hollow sphered MoO₂ nanocomposite, (b) N, P doped rGO/hollow sphered MoO₂ nanocomposite, (c) sphered molybdenum dioxide nanocomposite in which nitrogen is doped and reduced graphene oxide is dispersed on the surface (hereinafter referred to as N-doped rGO/hollow sphered MoO₂ nanocomposite), and (d) sphered molybdenum dioxide nanocomposite in which reduced graphene oxide is dispersed on the surface (hereinafter referred to as rGO/hollow sphered MoO₂ nanocomposite).

(a) is the composite synthesized using POM as a molybdenum dioxide precursor, and (b-d) are the composites synthesized using commercially available molybdenum dioxide. The composites (a) and (b) have the same environment of the molybdenum dioxide complex dispersed on the surface of N, P-doped reduced graphene, but (a) is a hollow structure and (b) is a spherical structure. This confirms that the hollow sphere structure is generated only when molybdenum dioxide particles are made using POM, regardless of the doping environment of the reduced graphene oxide surface.

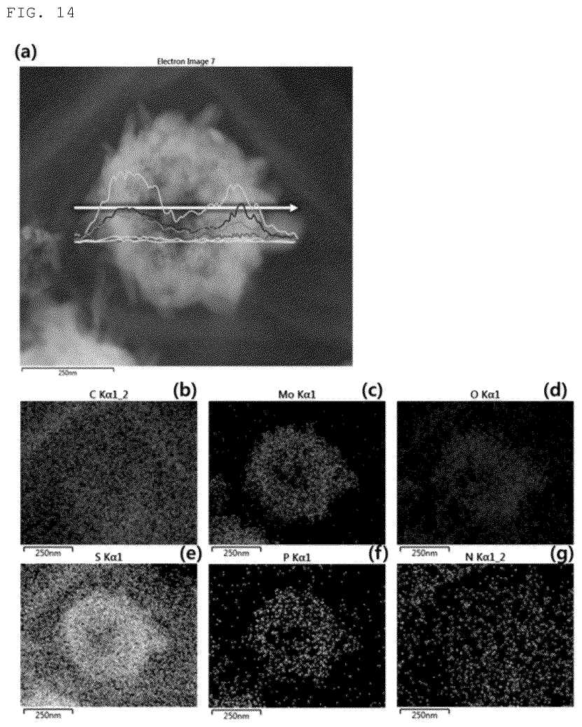

FIG. 13 shows transmission electron microscope (TEM) images for structural comparison according to the stirring time of (a) 5 hours, (b) 10 hours, (c) 20 hours, (d) more than 20 hours (for 40 hours) in the process of synthesizing the rGO/hollow sphered POM nanocomposite 100.

From the change of molybdenum dioxide nanoparticles according to the stirring for 5 hours, stirring for 10 hours, stirring for 20 hours, and stirring for more than 20 hours, it was found that the hollow sphered molybdenum dioxide nanoparticles were synthesized when stirring for 20 hours, and the particles collapsed when stirring for more than 20 hours.

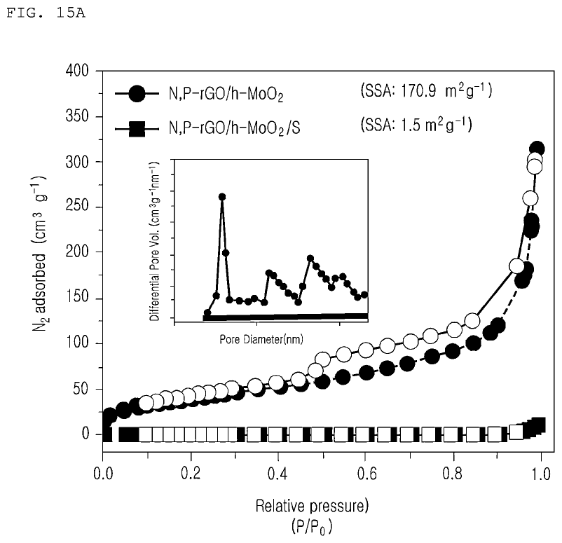

FIG. 14 shows (a) a high-magnification transmission electron microscope (TEM) image and (b to g) C, Mo, O, S, P, and N elemental mapping of a sulfur-supported N, P-doped rGO/hollow sphered MoOₛ/S nanocomposite.

In FIG. 14, (a) shows a form in which rod-shaped MoO₂/S primary particles (MoO₂/S rods) are agglomerated to form secondary spherical particles (hollow sphered particles). It can be seen from (b-g) that the surface of the MoO₂/S particle is coated with C, P, and N according to the EDS images.

In (a) in FIG. 14, the hollow sphered molybdenum dioxide nanoparticles still maintain their spherical shape structure well even after being loaded with sulfur.

In (a) in FIG. 14, it can be seen that the sulfur content (yellow graph) is relatively low due to the characteristics of the hollow structure.

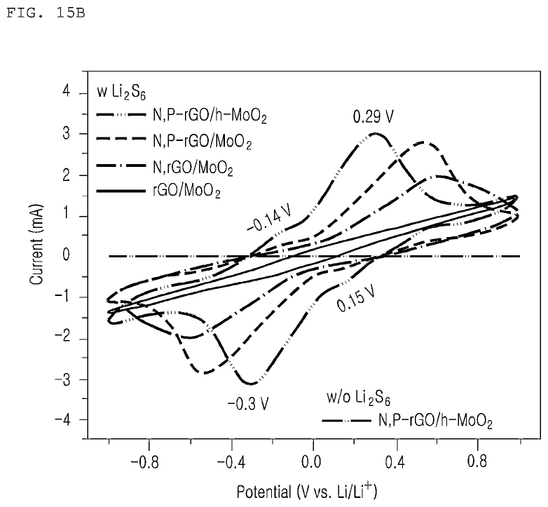

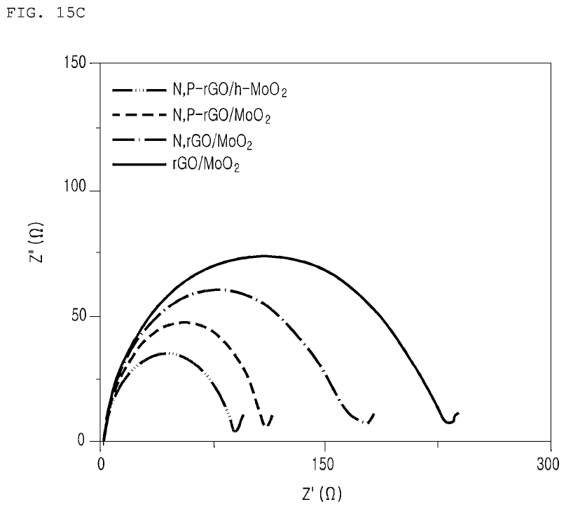

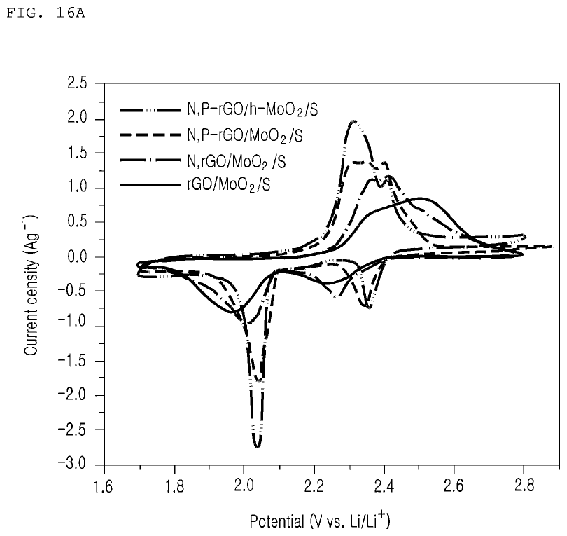

FIG. 15 shows (a) a BET curve, (b) symmetric cell polysulfide oxidation-reduction reaction current curve, (c) impedance curve (Nyquist plot) of a lithium sulfur battery electrode prepared of sulfur-supported N, P doped rGO/hollow sphered MoO₂/S nanocomposite 200.

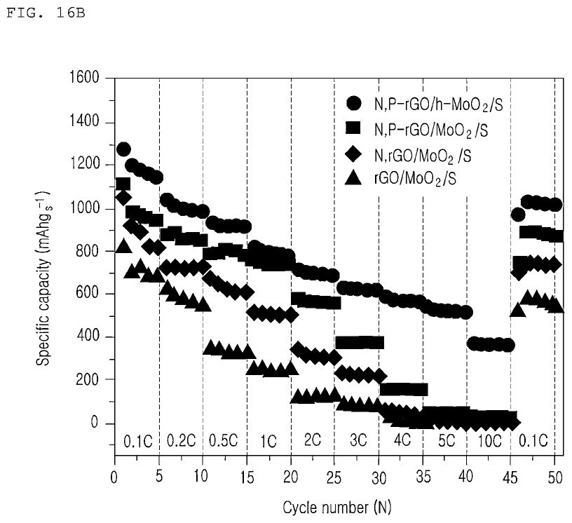

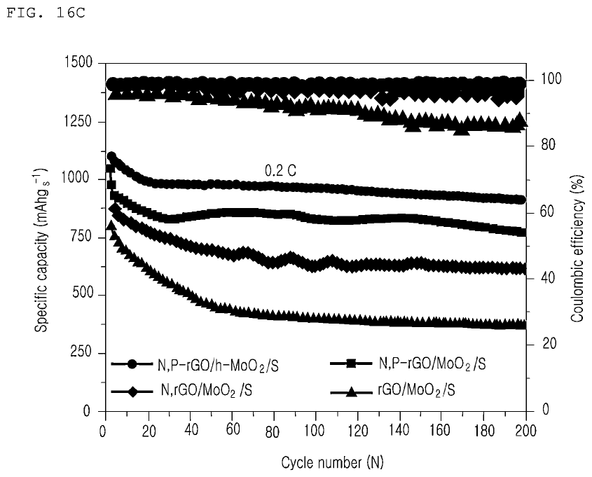

FIG. 16 shows (a) a cyclic scanning current (CV) curve, (b) scan rate characteristic evaluation curve, and (c) cyclic stability and capacity retention rate of a lithium sulfur battery electrode prepared of sulfur-supported N, P doped rGO/hollow sphered MoO₂/S nanocomposite 200.

Referring to FIGS. 15 and 16, it was confirmed that the lithium-sulfur battery using the N, P-doped rGO/hollow sphered MoO₂/S nanocomposite provided the best performance.

In the embodiments of the present disclosure, by preparing a layered structure in which bulk POM is uniformly distributed on the surface of rGO/PPy in a size of several nanometers, the effects of remarkably improving scan rate, capacity exhibiting, safety and energy density are provided compared to conventional ion batteries.

In addition, the embodiments of the present disclosure provide an effect of realizing high energy density by using the POM involving a plurality of electron reactions as a zinc storage host.

In addition, after uniformly distributing the polyoxometalate of the embodiment of the present disclosure in a nanoparticle size on the surface of the reduced graphene oxide/polypyrrole, the nanoparticle size is optimized through an Ostwald ripening method. Then, by using the hollow sphered molybdenum dioxide nanocomposite in which the nitrogen and phosphorous formed through heat treatment are doped and the reduced graphene oxide are dispersed on the surface as an energy storage material for a lithium-sulfur battery, the effects of solving the low conductivity of sulfur and volume expansion during charging and discharging and suppressing the polysulfide intermediate dissolution through nitrogen and phosphorus doping by the precursor are provided.

In addition, the embodiments of the present disclosure provide an effect of improving the electrochemical characteristics of a lithium sulfur battery through heteroatom doping and the hollow structure of nanoparticles by applying, to the electrode of the lithium sulfur battery, the hollow sphered molybdenum dioxide nanocomposite having heteroatom doping and hollowed nanoparticles in which nitrogen and phosphorus are doped and the reduced graphene oxide are dispersed on the surface.

The effect of the present disclosure is not limited to the above-mentioned effects, and it should be understood to include all possible effects deduced from the configuration of the disclosure described in the detailed description or the claims of the present disclosure.

The description of the present disclosure is used for exemplification and those skilled in the art will be able to understand that the present disclosure can be easily modified to other detailed forms without changing the technical idea or an essential feature thereof. Thus, it is to be appreciated that the embodiments described above are intended to be illustrative in every sense, and not restrictive. For example, each component described as a single type may be implemented to be distributed and similarly, components described to be distributed may also be implemented in an associated form.

The scope of the present disclosure is represented by the claims to be described below rather than the detailed description, and it is to be interpreted that the meaning and scope of the claims and all the changes or modified forms derived from the equivalents thereof come within the scope of the present disclosure.

### DESCRIPTION OF REFERENCE NUMERALS

1: multilayer reduced graphene oxide polypyrrole polyoxometalate laminated composite (L-rGO/PPy/POM laminated composite)
10: graphene oxide layer (GO layer)
12: reduced graphene oxide layer (rGO layer)
13: polypyrrole layer (PPy layer)
15: polyoxometalated layer (POM layer)
20: graphene oxide layer and polypyrrole layer laminate composite (GO/PPy laminated composite)
30: reduced graphene oxide layer polypyrrole layer and polyoxometalate layer laminated composite (rGO/PPy/POM laminated composite)
35: spherical reduced graphene oxide polypyrrole polyoxometalate composite (spherical rGO/PPy/POM composite)
100: N, P doped rGO/hollow sphered MoO₂ nanocomposite
200: N, P doped rGO/hollow sphered MoO₂/S nanocomposite
GO: graphene oxide
rGO: reduced graphene oxide
PPy: polypyrrole
POM: polyoxometalate

What is claimed is:

1. An ion battery electrode material comprising a multilayer reduced graphene oxide polypyrrole and polyoxometalate laminated composite (L-rGO/PPy/POM laminated composite) in which a plurality of reduced graphene oxide polypyrrole polyoxometalate laminated composites (rGO/PPy/POM laminated composite) is laminated such that a polyoxometalated layer (a POM layer) formed by uniformly dispersing nano polyoxometalate (POM) is positioned on a reduced graphene oxide layer (a rGO layer),
wherein the rGO/PPy/POM laminated composite is configured to comprise:
the reduced graphene oxide layer (the rGO layer);
a polypyrrole layer (a PPy layer) laminated on the rGO layer; and
the polyoxometalated layer (the POM layer) formed by uniformly dispersing the nano-polyoxometalate (POM) on the PPy layer.

2. The ion battery electrode material of claim 1, wherein the POM has a Aₐ(BC_{b}O_{c}) structure,
the A is selected from the group consisting of elements in group 1 of a periodic table (e.g. H, Li, Na, K, Rb, Cs, etc.), elements in group 2 of the periodic table (e.g. Mg, Ca, etc.), transition metals (e.g. Co, V, Fe, Cu, Fe etc.), NH₄, and ligand,
the B is one selected from the group consisting of heterogeneous elements (e.g., N, B, S, P, etc.), Al and Ni,
the C is one selected from the group consisting of Mo, V and W,
the a is a number ranging from 0 to 15,
the b is a number ranging from 6 to 368, and
the c is a number ranging from 0 to 110.

3. The ion battery electrode material of claim 1, wherein a weight ratio of the GO, PPy and POM is 2 to 3:9 to 10:87 to 89.

4. A method for manufacturing an ion battery electrode configured to comprise:
producing a graphene oxide (GO) solution by dispersing graphene oxide in a solvent,
producing a graphene oxide polypyrrole laminated composite (GO/PPy laminated composite) solution in which a graphene oxide layer and a polypyrrole layer are laminated by mixing poly pyrrole monomer (PPy) with the graphene oxide solution and then dispersing the poly pyrrole monomer;
producing a layered reduced graphene oxide polypyrrole polyoxometalate laminated composite (rGO/PPy/POM laminated composite) solution in which nano-polyoxometalated layer (a POM layer) uniformly dispersed on an upper portion of the PPy layer is laminated by mixing and reacting a polyoxometalated precursor (a POM precursor) with the GO/PPy laminated composite solution to convert the graphene oxide layer into a reduced graphene oxide layer (a rGO layer); and
producing a multilayered rGO/PPy/POM laminated composite (a L-rGO/PPy/POM laminated composite) solution in which a plurality of the rGO/PPy/POM laminated composites is laminated by stirring the rGO/PPy/POM laminated composite solution.

5. The method of claim 4, wherein the POM forming the POM precursor in producing the layered reduced graphene oxide polypyrrole polyoxometalate laminated composite (rGO/PPy/POM layered composite) solution has a Aₐ(BC_{b}O_{c}) structure,
the A is selected from the group consisting of elements in group 1 of a periodic table (e.g. H, Li, Na, K, Rb, Cs, etc.), elements in group 2 of the periodic table (e.g. Mg, Ca, etc.), transition metals (e.g. Co, V, Fe, Cu, Fe etc.), NH₄, and ligand,
the B is one selected from the group consisting of heterogeneous elements (e.g., N, B, S, P, etc.), Al and Ni,
the C is one selected from the group consisting of Mo, V and W,
the a is a number ranging from 0 to 15,
the b is a number ranging from 6 to 368, and
the c is a number ranging from 0 to 110.

6. The method of claim 4 wherein the dispersion of the graphene oxide in the producing the graphene oxide solution is performed by one or more selected from the group consisting of sonication for 1 to 3 hours, treatment of an organic solvent, and treatment of a surfactant.

7. The method of claim 4, wherein the dispersing of the PPy in the producing the GO/PPy laminated composite solution is performed by one or more selected from the group consisting of stirring the PPy for 0.2 to 1 hours, sonication for 0.2 to 1 hours, and treatment of an organic solvent.

8. The method of claim 4, wherein the stirring in the producing the layered L-rGO/PPy/POM laminated composite solution is performed for 20 to 28 hours.

9. The method of claim 4, wherein a weight ratio of the GO, PPy and POM is 2 to 3:9 to 10:87 to 89.

10. A method for synthesizing a hollow sphered molybdenum dioxide sulfur nanocomposite configured to comprise:
producing a graphene oxide polypyrrole mixture solution by dispersing graphene oxide in a solvent and then mixing with poly pyrrole (C₄H₅N, PPy) monomer;
producing a hollow sphered polyoxometalate nanocomposite (rGO/PPy/hollow sphered POM nanocomposite) solution in which reduced graphene oxide and polypyrrole are dispersed on a surface of hollow sphered polyoxometalate by mixing a polyoxometalate precursor (POM precursor) in the graphene oxide polypyrrole mixture solution and then stirring the mixture solution;
producing a hollow sphered molybdenum dioxide nanocomposite (rGO/PPy/hollow sphered MoO₂ nanocomposite) solution in which the reduced graphene oxide and the polypyrrole are dispersed on the surface by performing hydrothermal synthesis treatment of the rGO/PPy/hollow sphered POM nanocomposite solution to synthesize the polyoxometalate into molybdenum dioxide (MoO₂);
producing a hollow sphered molybdenum dioxide nanocomposite (N, P doped rGO/hollow sphered MoO₂ nanocomposite) in which nitrogen and phosphorus are doped and reduced graphene oxide is dispersed on the surface by heat-treating the rGO/PPy/hollow sphered MoO₂ nanocomposite; and
producing a nitrogen and phosphate doped reduced graphene oxide hollow sphered molybdenum dioxide sulfur nanocomposite (N, P doped rGO/hollow sphered MoO₂/S nanocomposite) by mixing sulfur with the N, P-doped rGO/hollow sphered MoO₂ nanocomposite and then heat-treating the mixture to impregnate the molybdenum dioxide with sulfur.

11. The method of claim 10, wherein in the producing the graphene oxide polypyrrole mixture solution, the graphene oxide and the pyrrole monomer are mixed in a mass ratio of 200:0.5 to 200:2.

12. The method of claim 10, wherein in the producing the rGO/PPy/hollow sphered POM nanocomposite solution, the polyoxometalate (POM) has a Aₐ(BC_{b}O_{c}),
the A is selected from the group consisting of an element in group 1 of a periodic table, an element in group 2 of the periodic table, a transition metal, NH₄, and ligand,
the B is one selected from the group consisting of a heterogeneous element, Al and Ni,
the C is one selected from the group consisting of Mo, V and W,
the a is a number ranging from 0 to 15,
the b is a number ranging from 6 to 368, and
the c is a number ranging from 0 to 110.

13. The method of claim 10, wherein in the producing the rGO/PPy/hollow sphered POM nanocomposite solution, the polyoxometalate (POM) is formed by doping one or more selected from the group consisting of a heterogeneous element and a transition metal to a (BC_{b}O_{c})⁻³ structure, the b is a number ranging from 6 to 368, and the c is a number ranging from 0 to 110.

14. The method of claim 10, wherein in the producing the rGO/PPy/hollow sphered POM nanocomposite solution, the polyoxometalate (POM) has a A₃(BC₁₂₋ₓDₓO₄₀),
the A is selected from the group consisting of an element in group 1 of a periodic table, an element in group 2 of the periodic table, a transition metal, NH₄, and ligand,
the B is one selected from the group consisting of a heterogeneous element, Al and Ni,
the C is one selected from the group consisting of Mo, V and W,
the D is substituted with a transition metal,
the a is a number ranging from 0 to 15,
the b is a number ranging from 6 to 368, and
the c is a number ranging from 0 to 110.

15. The method of claim 10, wherein in the producing the rGO/PPy/hollow sphered POM nanocomposite solution, the polyoxometalate (POM) added is 0.05 mmol or more and 0.2 mmol or less, and the stirring is performed for 15 to 20 hours.

16. The method of claim 10, wherein in the producing the N, P doped rGO/hollow sphered MoO₂ nanocomposite, the heat treatment is performed at 850 to 950° C. for 1 to 3 hours to activate heteroatom doping by a carbonization process, so that the nitrogen of polypyrrole and the phosphorus of polyoxometalate are doped to produce the N, P doped rGO/hollow sphered MoO₂ nanocomposite.

17. The method of claim 10, wherein in the producing the N, P doped rGO/hollow sphered MoO₂ nanocomposite, the N, P-doped rGO/hollow sphered MoO₂ nanocomposite and sulfur are mixed in a mass ratio of 1:2 to 1:4 and then the mixture is heat-treated to impregnate the molybdenum dioxide with the sulfur to produce the nitrogen and phosphate doped reduced graphene oxide hollow sphered molybdenum dioxide sulfur nanocomposite (N, P-doped rGO/hollow sphered MoO₂/S nanocomposite).

18. A hollow sphered molybdenum dioxide sulfur nanocomposite which is a hollow sphered molybdenum dioxide sulfur nanocomposite (a N, P doped rGO/hollow sphered MoO₂/S nanocomposite) in which nitrogen and phosphorus are doped and reduced graphene oxide is dispersed on a surface, and which has a structure formed by impregnating sulfur in a hollow sphered molybdenum dioxide nanocomposite (a N, P doped rGO/hollow sphered MoO₂ nanocomposite) in which the nitrogen and the phosphorus are doped and the reduced graphene oxide is dispersed on the surface and which has a structure in which the nitrogen and the phosphorus are doped and the reduced graphene oxide is dispersed on a surface of the hollow sphered molybdenum dioxide nanocomposite formed of MoO₂ nanorods.

19. The hollow sphered molybdenum dioxide sulfur nanocomposite of claim 18, wherein a mass ratio between the N, P-doped rGO/hollow sphered MoO₂ nanocomposite and the sulfur is 1:2 to 1:6.
